(19) United States
(12) Patent Application Publication
(10) Pub. No.: US 2005/0184598 A1
(43) Pub. Date: Aug. 25, 2005

(54) Device for controlling a gearbox, in particular for a motor vehicle

(76) Inventors: Jean-Pierre Baz, Passy (FR); Daniel Guimet, Sixt Fer A Cheval (FR); Jean-Loup Florens, Grenoble Cedex (FR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 11/034,658

(22) Filed: Jan. 13, 2005

(30) Foreign Application Priority Data
Jan. 15, 2004 (FR) 0400372

(51) Int. Cl. B60K 41/22; H02K 41/00

(52) U.S. Cl. 310/12

(57) ABSTRACT

A device for controlling an automatic gearbox, in particular for a motor vehicle, the device comprising means for actuating a selector shaft pivotally mounted in the gearbox, the actuator means being formed by a flat electric actuator comprising a flat coil mounted to pivot about a stationary pin between two flat permanent magnets carried by a yoke.

The present invention relates to a device for controlling an automatic gearbox, in particular for a motor vehicle, the device comprising means for actuating at least one selector shaft pivotally mounted in the gearbox.

### BACKGROUND OF THE INVENTION

In the traditional technique, the selector lever is connected to the gearbox via a system of cables or rodding, and the drawbacks of such systems are well known.

Proposals have already been made to replace such a cable or rodding system with an electric motor and gearbox unit associated with a selector lever that controls microswitches on being moved into its various positions. Nevertheless, electric motor and gearbox units suffer from the drawbacks of a relatively long response time (typically about 400 milliseconds (ms) to 700 ms), and of being irreversible, which means that they must be controlled very accurately since the selector shaft of the gearbox must be driven by the motor and gearbox unit so as to be placed exactly in one of its predetermined selection positions.

### OBJECTS AND SUMMARY OF THE INVENTION

A particular object of the present invention is to provide a gearbox control device which avoids the drawback of prior art devices.

To this end, the invention provides a device for controlling an automatic gearbox, in particular for a motor vehicle, the device including actuator means for actuating at least one selector shaft pivotally mounted in the gearbox, wherein the actuator means are formed by a flat electrical actuator comprising a flat coil mounted to pivot about a stationary pin between two flat permanent magnets carried by a yoke, connection means connecting the coil to the selector shaft of the gearbox, and means for electrically powering the coil, suitable for causing an electric current to pass in one direction or the other through the coil to cause it to turn in one direction or the other about the above-mentioned stationary pin.

The device of the invention thus considerably reduces friction and the risk of jamming since it contains no gearing, no sliding cables, and no rodding. In addition, it is reversible, which makes it possible to control the actuator with modest accuracy since it is no longer necessary to bring the selector shaft exactly into a predetermined position. It suffices to bring the shaft into the vicinity of a predetermined position, after which resilient positioning means such as ball means or the like associated with the selector shaft act on the shaft to bring it into its exact selection position, with the reversibility of the drive from the actuator allowing this displacement to take place without impeding it.

In addition, the response time of such a control device is short, typically being about 70 ms.

According to another characteristic of the invention, the device includes means for controlling the electrical power supply to the coil so as to cause an electric current to pass through the coil in a determined direction for a determined duration as a function of electrical signals generated by the speed selector means.

The means for electrically powering the coil can thus be controlled in a manner that is a particularly simple and reliable.

According to another characteristic of the invention, the device includes a position or displacement sensor associated with the coil and supplying a signal corresponding to an angular displacement of the coil about the above-mentioned stationary pin, said sensor being mounted in a feedback loop of the means for controlling electrical power supply to the coil.

This thus servo-controls the displacement of the coil between the various gear selection positions in a manner that is simple and precise.

Advantageously, the sensor is of the contactless type, such as a magnetoresistance sensor, for example.

Such a sensor is insensitive to variations in the temperature of the permanent magnets and withstands vibration well. In addition, it delivers a signal that is proportional to the angular displacement of the coil about its pivot axis.

In an embodiment of the invention, the coil is mounted on the selector shaft of the gearbox, which forms the pivot axis of the coil.

In a variant embodiment of the invention, the coil is connected to the selector shaft of the gearbox via at least one link, e.g. including means for adjusting-its length.

The adjustment means enable the flat coil to be angularly prepositioned with accuracy, by comparing and accommodating dispersions in dimensions and tolerances.

These two embodiments enable the device of the invention to be used in any type of vehicle merely by adapting the connection between the coil and the selector shaft of the gearbox.

Advantageously, the means for electrically powering the coil comprise a DC-DC converter, i.e. a direct current to direct current converter.

This enables operating current levels to be reduced, simplifies the control of the electrical power supply to the coil, reduces losses by the Joule effect and thus improves the efficiency of the device, and reduces the reaction magnetic field of the coil.

According to another characteristic of the invention, the selector shaft of the gearbox is associated with a ball plate for ensuring that said shaft is accurately positioned in each of its predetermined angular positions for selecting a gear.

In an embodiment of the invention, the permanent magnets of the actuator means are neodymium iron boron magnets.

The use of neodymium iron boron magnets can achieve the ability to operate at high temperature and to withstand demagnetization.

In a variant embodiment of the invention, the permanent magnets of the actuator means are samarium cobalt magnets.

### BRIEF DESCRIPTION OF THE DRAWINGS

Other advantages and characteristics of the invention appear on reading the following detailed description of a non-limiting example given with reference to the accompanying drawings, in which:

FIG. 1 is a block diagram of a gearbox control device of the invention;

FIG. 2 is a block diagram of the control circuit of the FIG. 1 device;

FIG. 3 is an exploded diagrammatic perspective view of the actuator;

FIGS. 4 and 5 show two variant connections between the actuator and the selector shaft of the gearbox; and

FIG. 6 is a diagrammatic view of a magnetoresistance sensor used in the device of the invention.

### MORE DETAILED DESCRIPTION

In FIG. 1, reference 1 designates gear selector means, such as in particular a lever for turning a selector shaft 3 of an automatic gearbox of a motor vehicle.

The selector lever 1 is actuated by the driver of the vehicle and it moves in a gate having a plurality of predetermined positions, e.g. of the P-R-N-D type, with the lever being positioned in any one of those positions serving to actuate a switch delivering an output signal that is transmitted to a control circuit 4.

The control circuit 4 generates a control signal for an actuator 5 which turns the selector shaft 3 in one direction or the other in order to bring it into a predetermined position corresponding to the position of the lever 1.

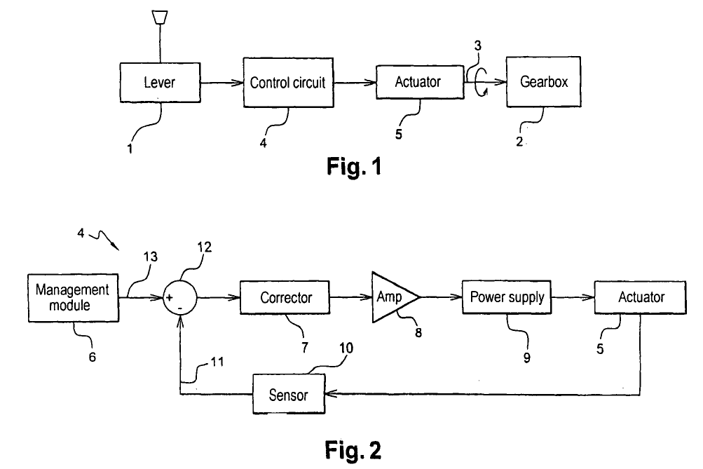

The control circuit 4, which is shown in greater detail in FIG. 2, comprises a management module 6 controlled by the vehicle computer and generating a reference signal which is applied by a corrector 7 and an amplifier 8 to means 9 for electrically powering the actuator 5.

A position or displacement sensor 10 is associated with the outlet from the actuator 5 and generates an electrical signal 11 which is applied to an input of a comparator 12 whose other input receives the reference signal 13 delivered by the management module 6. The output from the comparator 12 represents the difference between the signals 11 and 13 and it is applied by the corrector 17 and the amplifier 8 to the means 9 that generate an electric current of determined magnitude, direction, and duration.

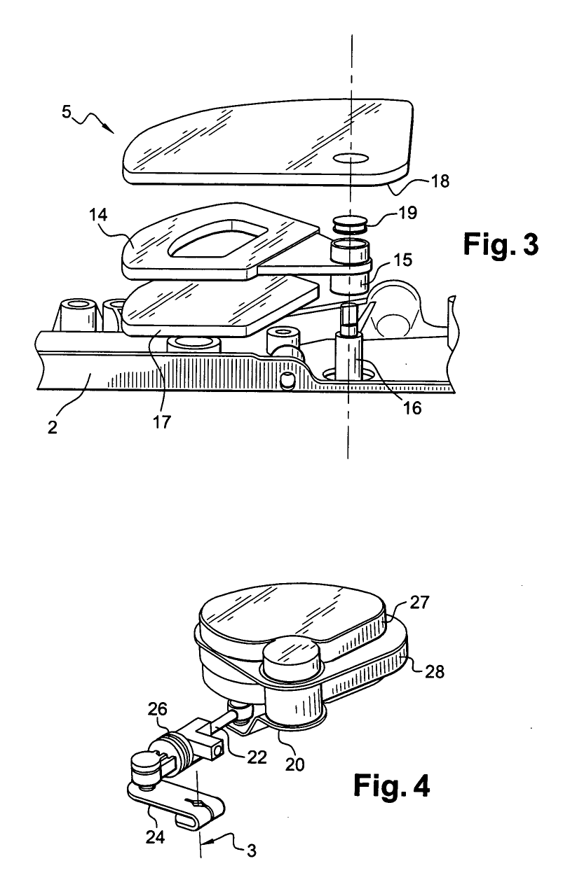

The actuator 5 is a flat electric motor, and in an embodiment as shown in FIG. 3 it comprises a flat coil 14 in the form of an angular sector that is pivotally mounted by means of a bushing 15 to pivot about a stationary pin 16.

Flat electric actuators of this type are known, in particular from French patent No. 2 638 273 which describes a flat electric motor made up of a juxtaposition of flat coils slidably mounted on slideways and separated by permanent magnets. Supplying electricity to the coils induces a magnetic field that opposes the bias of the permanent magnet and causes the coil to move sideways along their slideways.

The flat coil 14 of the actuator in the device of the invention is suitable for pivoting between two stationary flat permanent magnets 17 and 18 that are carried by a yoke (not shown) for closing the magnetic field. The flat permanent magnets 17 and 18 are preferably neodymium iron boron magnets or samarium cobalt magnets.

In an embodiment, the flat coil 14 extends angularly over about 45° and comprises 90 to 120 turns of copper wire having a diameter of about 1 millimeter (mm). The electrical resistance of the coil lies in the range 0.3 ohms (Ω) to 0.9 Ω at about 25° C. Its inductance lies in the range 0.3 millihenries (mH) to 0.9 mH. The thickness of the copper wire windings is about 8 mm.

Each of the flat magnets 17, 18 extends over an angle of about 90°. The magnets generate a magnetic field of about 1.1 teslas (T) to 1.2 T and withstand a coercive field (demagnetization) of about 900 kiloamps per meter (kA/m) to 2000 kA/m. They are about 5 mm to 10 mm thick.

Each magnet 17, 18 extending over about 90°, could be replaced by two substantially juxtaposed magnets each extending over 45°.

As a function of the electrical signals generated by the gear selector means 1, the electrical power supply means 9 cause an electric current of determined duration and determined direction to pass through the coil 14. The means 9 for electrically powering the actuator 5 preferably comprise a DC-DC converter so as to reduce considerably operating currents, actuator response time, and losses by the Joule effect.

Angular displacements of the coil 12 are detected by a position or displacement sensor 19 carried by the bushing 15 and turning relative to the permanent magnet 18 in order to provide a signal corresponding to the pivoting of the coil 14 about the stationary pin 16. The sensor 19 is of the contactless type, for example a magnetoresistance sensor, of a structure that is described in greater detail below with reference to FIG. 6.

The bushing 15 of the coil 14 may be connected to the selector shaft 3 of the gearbox in various different ways.

In FIG. 3, the bushing 15 of the coil 12 is mounted directly on the selector shaft 3 of the gearbox 2. This configuration has the advantage of simplicity.

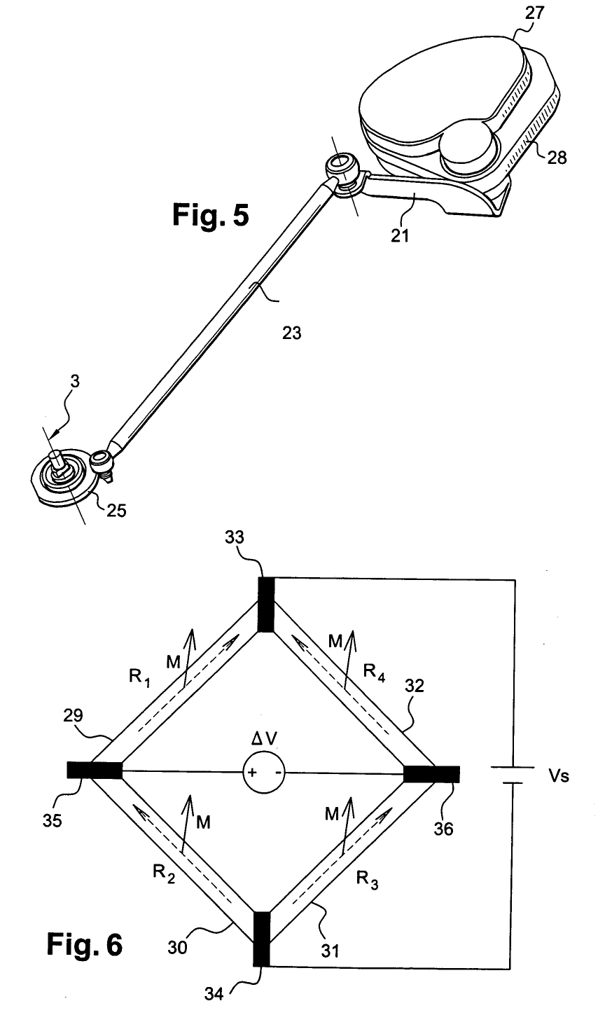

In FIGS. 4 and 5, the connection means comprise a lever 20 or 21 constrained to pivot with the bushing 15 of the coil, and connected at its opposite end by a link 22 or 23 to another lever 24 or 25 whose other end is constrained to turn with the selector shaft of the gearbox.

In FIG. 4, the link 22 includes length adjustment means 26 enabling the angular position of the coil 14 to be adjusted relative to a determined position of the selector shaft 3 so as to compensate for dispersion in dimensions and tolerances. The adjustment means 26 can be of any suitable type, for example comprising a nut screwed onto a threaded rod with means for locking the nut against turning. By way of example, the means 26 may provide length compensation of about 10 mm, corresponding to an angular offset of ±0.7° at the actuator.

The selector shaft 3 of the gearbox 2 is preferably associated with angular positioning means such as a resilient ball plate which ensures that the shaft is positioned very accurately in any one of the predetermined P-R-N-D angular positions once the shaft 3 comes close to any such position.

Thus, if for any reason whatsoever the actuator does not bring the shaft 3 into its predetermined position, but brings it only into a nearby position, the ball finishes off moving the shaft 3 into position. This ensures that control is very reliable.

The actuator of FIGS. 4 and 5 is housed in a protective box made by assembling together two casings 27 and 28 suitable for acting as an assembly yoke for the above-mentioned permanent magnets 17, 18.

FIG. 6 is a diagram of a magnetoresistance sensor comprising four sensing elements 29 to 32 made of ferrous material, for example, mounted as a Wheatstone bridge with two opposite terminals 33 and 34 being connected to an electrical power supply Vs, and with the other two terminals 35 and 36 forming the output terminals of the sensor, with an output voltage ΔV being generated between them. In FIG. 1, this output voltage ΔV is applied to one input of a comparator 12. The electrical resistances R1, R2, R3, and R4 of the sensing elements 29 to 32 vary as a function of the angle between the magnetization produced in the sensing elements 29 to 32 by magnetic induction M generated by the permanent magnet 18 of FIG. 3, and the direction in which the electric current flows through the sensing elements 29 to 32. When the magnetic induction M is greater than a certain value, the sensing elements 29 to 32 become magnetically saturated and their resistances R1, R2, R3, and R4 vary as a function to the square of the cosine of the angle between the magnetic induction M and the flow direction of the electric current in the elements 29 to 32.

In general, the invention also applies to controlling a gearbox having a selector and engagement shaft, in which case the device comprises two actuators of the above-specified type for moving the shaft in translation and in pivoting.

1. A device for controlling an automatic gearbox, in particular for a motor vehicle, the device including actuator means for actuating at least one selector shaft pivotally mounted in the gearbox, wherein the actuator means are formed by a flat electrical actuator comprising a flat coil mounted to pivot about a stationary pin between two flat permanent magnets carried by a yoke, connection means connecting the coil to the selector shaft of the gearbox, and means for electrically powering the coil, suitable for causing an electric current to pass in one direction or the other through the coil to cause it to turn in one direction or the other about the above-mentioned stationary pin.

2. A device according to claim 1, including means for controlling the electrical power supply to the coil so as to cause an electric current to pass through the coil in a determined direction for a determined duration as a function of electrical signals generated by the speed selector means.

3. A device according to claim 2, including a position or displacement sensor associated with the coil and supplying a signal corresponding to an angular displacement of the coil about the above-mentioned stationary pin, said sensor being mounted in a feedback loop of the means for controlling electrical power supply to the coil.

4. A device according to claim 3, wherein the sensor is of the contactless type, such as a magnetoresistance sensor, for example.

5. A device according to claim 1, wherein the coil is mounted on the selector shaft of the gearbox, which forms the pivot axis of the coil.

6. A device according to claim 1, wherein the coil is connected to the selector shaft of the gearbox via at least one link, e.g. including means for adjusting its length.

7. A device according to claim 1, wherein the means for electrically powering the coil comprise a DC-DC converter.

8. A device according to claim 1, wherein the device is reversible, and wherein the selector shaft of the gearbox is associated with resilient positioning means for ensuring that said shaft is positioned in any one of a plurality of predetermined angular positions.

9. A device according to claim 1, wherein the permanent magnets of the actuator means are neodymium iron boron magnets.

10. A device according to claim 1, wherein the permanent magnets of the actuator means are samarium cobalt magnets.
